(19) United States
(12) Patent Application Publication
(10) Pub. No.: US 2026/0194124 A1
(43) Pub. Date: Jul. 9, 2026

(54) CRANK SPEED REDUCER

(71) Applicant: Ali Mahmoodi, Tehran (IR)

(72) Inventor: Ali Mahmoodi, Tehran (IR)

(21) Appl. No.: 19/133,733

(22) PCT Filed: Dec. 6, 2023
(86) PCT No.: PCT/IB2023/062297

§ 371 Date: May 29, 2025

(51) Int. Cl. F16H 1/32

(52) U.S. Cl. CPC F16H 1/32

(57) ABSTRACT

A crank speed reducer includes a middle planetary ring gear, a rotating mechanism, an output sun gear, a first driven ring wheel, a second driven ring wheel, and a central output shaft. The middle planetary ring gear includes an internal-cut gear inside a cylindrical internal surface of the middle planetary ring gear. The rotating mechanism is directly connected to the middle planetary ring gear and drives a rotational movement of the middle planetary ring gear. The output sun gear is meshed with the internal-cut gear. The output sun gear is rotatable with the middle planetary ring gear. The first driven ring wheel is coupled to the first middle planetary ring gear from a first side of the middle planetary ring gear. The second driven ring wheel is coupled to the middle planetary ring gear from a second side of the middle planetary ring gear.

### TECHNICAL FIELD

The present disclosure generally relates to speed reducer mechanisms, and particularly, to planetary and epicycloidal (or epicyclical) high-ratio gear reducers. More particularly, the present invention relates to a compact pericycloidal high-ratio gear reducer.

### BACKGROUND ART

A fundamental requirement of majority of devices that utilize mechanical power is transmission of rotational movement of a power source, such as an electric motor or an internal combustion engine, to a low-speed power consumer or end effector. One way to address this requirement may be utilization of conventional gear boxes with multistage gear trains. However, such multistage gear boxes may be relatively large and heavy for applications where high reduction ratios are required.

Planetary or epicyclical gear transmissions are well-known power transmission systems which provide compact, high power and torque density, reliable, low backlash and high efficiency gearing [U.S. Pat. No. 9,288,022 B2]. However, conventional planetary power transmission systems may have complicated manufacturing processes due to high accuracy requirement in dimensions, finishing and placement of gears. Moreover, conventional planetary power transmission systems may provide relatively low reduction ratios unless multi-stages be consecutively coupled. There is, therefore, a need for a cost-efficient power transmission mechanism that may provide a high reduction ratio in a single stage without a complex structure.

### SUMMARY OF THE INVENTION

This summary is intended to provide an overview of the subject matter of this patent, and is not intended to identify essential elements or key elements of the subject matter, nor is it intended to be used to determine the scope of the claimed implementations. The proper scope of this patent may be ascertained from the claims set forth below in view of the detailed description below and the drawings.

In one general aspect, the present disclosure describes an exemplary crank speed reducer. An exemplary crank speed reducer may include a first middle planetary ring gear, a rotating mechanism, a first output sun gear, a first driven ring wheel, a second driven ring wheel, and a central output shaft. An exemplary first middle planetary ring gear may include a first internal-cut gear inside a cylindrical internal surface of the first middle planetary ring gear. In an exemplary embodiment, a rotation axis of the first internal-cut gear may overlap and may be along with a central normal axis of the first middle planetary ring gear. An exemplary rotating mechanism may be directly connected to the first middle planetary ring gear and may drive a rotational movement of the first middle planetary ring gear. An exemplary first output sun gear may be meshed with the first internal-cut gear. In an exemplary embodiment, a rotation axis of the first output sun gear may be parallel with the central normal axis of the first middle planetary ring gear. An exemplary first output sun gear may be rotatable with the first middle planetary ring gear.

An exemplary first driven ring wheel may be rotatable about a first rotation axis. An exemplary first rotation axis may overlap and may be along with a central normal axis of the first driven ring wheel and may be parallel with the central normal axis of the first middle planetary ring gear. An exemplary first driven ring wheel may be coupled to the first middle planetary ring gear from a first side of the first middle planetary ring gear utilizing a first prismatic joint. An exemplary first prismatic joint may be disposed on a plane that may be perpendicular to the first rotation axis. An exemplary first prismatic joint may transfer the rotational movement of the first middle planetary ring gear to the first driven ring wheel.

An exemplary second driven ring wheel may be rotatable about a second rotation axis. An exemplary second rotation axis may overlap and may be along with a central normal axis of the second driven ring wheel and may be parallel with the central normal axis of the first middle planetary ring gear. An exemplary central output shaft may be coupled to the first output sun gear. An exemplary central output shaft may be rotatable with the first output sun gear about a central axis. An exemplary central axis may overlap and may be along with a central longitudinal axis of the central output shaft.

In an exemplary embodiment, the first rotation axis, the second rotation axis, and the central axis may be parallel with each other and may lie on a single plane. An exemplary first rotation axis and an exemplary second rotation axis may be symmetrically disposed on either side of the central axis with equal respective distances from the central axis.

An exemplary second driven ring wheel may be coupled to the first middle planetary ring gear from a second side of the first middle planetary ring gear utilizing a second prismatic joint. An exemplary second prismatic joint may be disposed on a plane perpendicular to the second rotation axis and may transfer the rotational movement of the first middle planetary ring gear to the second driven ring wheel. In an exemplary embodiment, a sliding direction of the second prismatic joint may be perpendicular to a sliding direction of the first prismatic joint.

An exemplary rotating mechanism may include an input shaft and an eccentric cylinder. An exemplary input shaft may be rotatable about the central axis. An exemplary eccentric cylinder may be attached to one end of the input shaft. In an exemplary embodiment, an eccentricity of the eccentric cylinder relative to the central axis may be equal to the distance of the first rotation axis from the central axis.

An exemplary first middle planetary ring gear may further include a central hole and a bearing. An exemplary bearing may be fitted to the central hole and may allow the first middle planetary ring gear to rotate relative to the eccentric cylinder about the central normal axis of the first middle planetary ring gear by rotatably coupling the eccentric cylinder to the first middle planetary ring gear.

An exemplary crank speed reducer may further include a first wall and a second wall. An exemplary first wall may include a first bearing. An exemplary first bearing may be coupled to the first driven ring wheel and may allow the first driven ring wheel to rotate about the first rotation axis. An exemplary second wall may include a second bearing. An exemplary second bearing may be coupled to the second driven ring wheel and may allow the second driven ring wheel to rotate about the second rotation axis. In an exemplary embodiment, the first wall and the second wall may be fixed in position with respect to each other.

In an exemplary embodiment, the input shaft may be partially hollow and may allow the central output shaft to coaxially pass through the input shaft. In an exemplary embodiment, the central output shaft may be partially hollow and may allow the input shaft to coaxially pass through the central output shaft.

An exemplary first wall may further include a first hole. An exemplary first hole may be fitted with a third bearing and may allow one of the input shaft and the central output shaft to pass through the first wall and be rotatably coupled to the first wall through the third bearing. An exemplary second wall may further include a second hole. An exemplary second hole may be fitted with a fourth bearing and may allow one of the input shaft and the central output shaft to pass through the second wall and be rotatably coupled to the second wall through the fourth bearing.

An exemplary first driven ring wheel may include a first central hole. An exemplary first central hole may allow one of the input shaft and the central output shaft to pass through the first driven ring wheel. An exemplary second driven ring wheel may include a second central hole. An exemplary second central hole may allow one of the input shaft and the central output shaft to pass through the second driven ring wheel.

In an exemplary embodiment, the rotating mechanism may include a rotating wall, a first bearing, and a second bearing. An exemplary rotating wall may include an eccentric hole. An exemplary first bearing may be fitted to the rotating wall and may allow the rotating wall to rotate about the central axis. An exemplary second bearing may be fitted to the eccentric hole and may rotatably couple the first middle planetary ring gear to the eccentric hole. An exemplary central normal axis of the eccentric hole may be parallel with the central axis. An exemplary eccentricity of the eccentric hole relative to the central axis may be equal to a distance of the first rotation axis from the central axis.

In an exemplary embodiment, the rotating mechanism may include a rotating wall, a first bearing, a second bearing, a third bearing, a second middle planetary ring gear, and a second output sun gear. An exemplary rotating wall may include a first eccentric hole and a second eccentric hole. An exemplary first eccentric hole may be located at a proximal side of the rotating wall. An exemplary proximal side may face the first middle planetary ring gear. In an exemplary embodiment, a central normal axis of the first eccentric hole may be parallel with the central axis and an eccentricity of the first eccentric hole relative to the central axis may be equal to a distance of the first rotation axis from the central axis. In an exemplary embodiment, a central normal axis of the second eccentric hole may be parallel with the central axis and an eccentricity of the second eccentric hole relative to the central axis may be equal to a distance of the second rotation axis from the central axis. In an exemplary embodiment, the first eccentric hole and the second eccentric hole may be disposed on opposite sides of the rotating wall. An exemplary first bearing may be fitted to the rotating wall and may allow the rotating wall to rotate about the central axis. An exemplary second bearing may be fitted to the first eccentric hole. In an exemplary embodiment, the second bearing may rotatably couple the first middle planetary ring gear to the first eccentric hole and may allow the first middle planetary ring gear to rotate about the central normal axis of the first middle planetary ring gear. An exemplary second middle planetary ring gear may be coupled to the second driven ring wheel from a respective side of the second middle planetary ring gear utilizing a second prismatic joint that may transfer a rotational movement of the second middle planetary ring gear to the second driven ring wheel. An exemplary respective side of the second middle planetary ring gear may be positioned opposite to the first side of the first middle planetary ring gear along the central axis. An exemplary second middle planetary ring gear may include a second internal-cut gear inside a cylindrical internal surface of the second middle planetary ring gear. In an exemplary embodiment, a rotation axis of the second internal-cut gear may overlap and may be along with a normal central axis of the second middle planetary ring gear. An exemplary second eccentric hole may be fitted with the third bearing that may rotatably couple the second middle planetary ring gear to the second eccentric hole and may allow the second middle planetary ring gear to rotate about the central normal axis of the second middle planetary ring gear. An exemplary second output sun gear may be meshed with the second middle planetary ring gear and may be rotatable with the second middle planetary ring gear about the central axis. In an exemplary embodiment, a central normal axis of the second output sun gear may overlap and may be along with the central axis and a gear ratio between the second middle planetary ring gear and the second output sun gear may be equal to a gear ratio between the first middle planetary ring gear and the first output sun gear. An exemplary second output sun gear may be attached to the central output shaft and may include a fixed position relative to the first output sun gear.

An exemplary first middle planetary ring gear may further include a central hole. An exemplary central hole may be fitted with a fourth bearing that may allow the first middle planetary ring gear to rotate relative to the eccentric cylinder about the central normal axis of the first middle planetary ring gear by rotatably coupling the eccentric cylinder to the first middle planetary ring gear.

An exemplary first driven ring wheel may include a first central hole that may allow one of the input shaft and the central output shaft to pass through the first driven ring wheel. An exemplary second driven ring wheel may include a second central hole that may allow one of the input shaft and the central output shaft to pass through the second driven ring wheel.

Other exemplary systems, methods, features and advantages of the implementations will be, or will become, apparent to one of ordinary skill in the art upon examination of the following figures and detailed description. It is intended that all such additional systems, methods, features and advantages be included within this description and this summary, be within the scope of the implementations, and be protected by the claims herein.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1A shows a schematic of an exploded right view of a coaxial crank speed reducer, consistent with one or more exemplary embodiments of the present disclosure.

FIG. 1B shows a schematic of an exploded view of an input shaft inserted inside a hollow output shaft, consistent with one or more exemplary embodiments of the present disclosure.

FIG. 1C shows a schematic of a driven ring wheel of a coaxial crank speed reducer with a central hole, consistent with one or more exemplary embodiments of the present disclosure.

FIG. 2 shows a schematic of a rotating-wall crank speed reducer, consistent with one or more exemplary embodiments of the present disclosure.

FIG. 3 shows a schematic of an exploded right view of a twin-planet crank speed reducer with a rotating wall, consistent with one or more exemplary embodiments of the present disclosure.

FIG. 4A shows a schematic of an exploded right view of a twin-planet crank speed reducer with a rotating wall and an input shaft, consistent with one or more exemplary embodiments of the present disclosure.

FIG. 4B shows a schematic of a driven ring wheel of a twin-planet crank speed reducer with a central hole, consistent with one or more exemplary embodiments of the present disclosure.

### DESCRIPTION OF THE INVENTION

In the following detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

The following detailed description is presented to enable a person skilled in the art to make and use the methods and devices disclosed in exemplary embodiments of the present disclosure. For purposes of explanation, specific nomenclature is set forth to provide a thorough understanding of the present disclosure. However, it will be apparent to one skilled in the art that these specific details are not required to practice the disclosed exemplary embodiments. Descriptions of specific exemplary embodiments are provided only as representative examples. Various modifications to the exemplary implementations will be readily apparent to one skilled in the art, and the general principles defined herein may be applied to other implementations and applications without departing from the scope of the present disclosure. The present disclosure is not intended to be limited to the implementations shown, but is to be accorded the widest possible scope consistent with the principles and features disclosed herein.

Herein is disclosed an exemplary crank speed reducer. An exemplary crank speed reducer may include a planetary ring gear and a rotation mechanism (such as an input shaft or a rotating wall or combination of those) that may rotate planetary ring gear by being directly connected to the planetary ring gear. An exemplary planetary ring gear in turn may drive an output sun gear. An exemplary rotating mechanism with a rotating wall may include a second planetary ring gear as a conjugate of the first planetary ring gear. An exemplary second planetary ring gear may be coupled to the first one via meshing with a second output sun gear which is conjoined to the first output sun gear. An exemplary pair of driven ring wheels may be respectively coupled to two corresponding sides of the one or two planetary ring gears and may be rotatable with the one or two planetary ring gears. A proper configuration and coupling of an exemplary pair of driven ring wheels to two sides of the one or two planetary ring gears may cause the one or two planetary ring gears to perform a compound rotation in response to a rotation of an exemplary rotating mechanism. An exemplary compound rotation may consist of spinning and a revolution on a circular orbit. Exemplary spinning and revolutionary motions of the one or two planetary ring gears may be transmitted to one or two conjoined output sun gears. In an exemplary response to such compound movement of the one or two planetary ring gears, the one or two conjoined output sun gears may rotate about a common axis. As a result, an exemplary rotational movement of the one or two conjoined output sun gears may be directly transmitted to an exemplary output shaft which may be coupled to the one or two conjoined output sun gears.

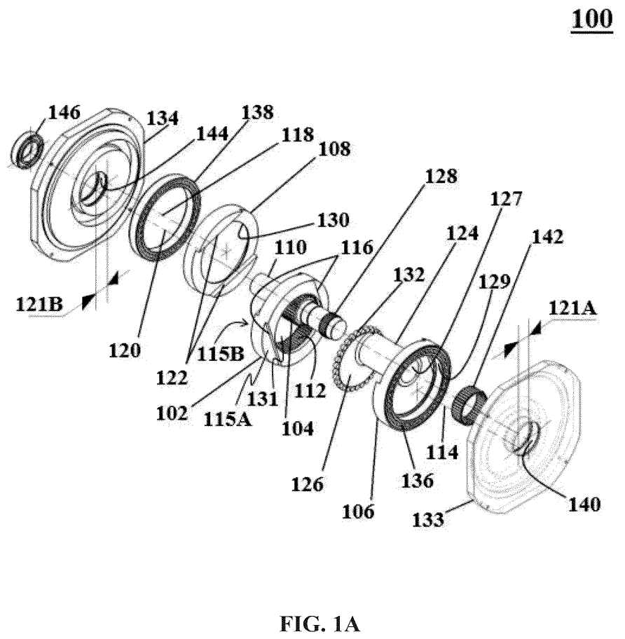

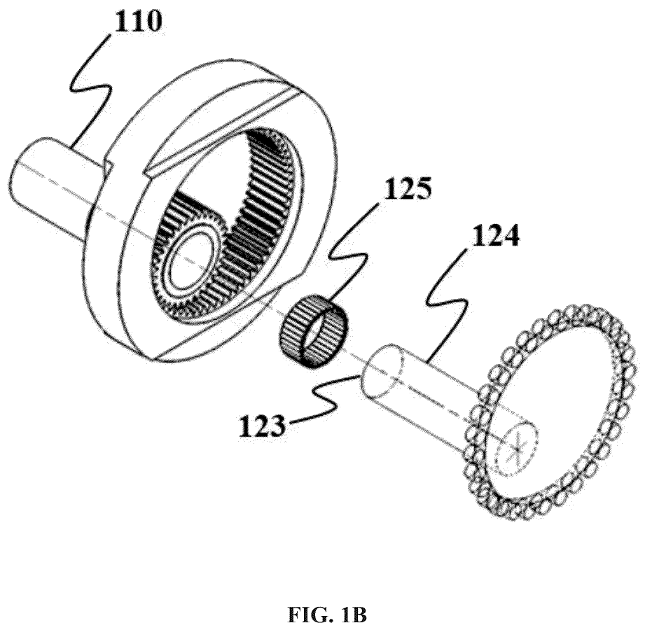

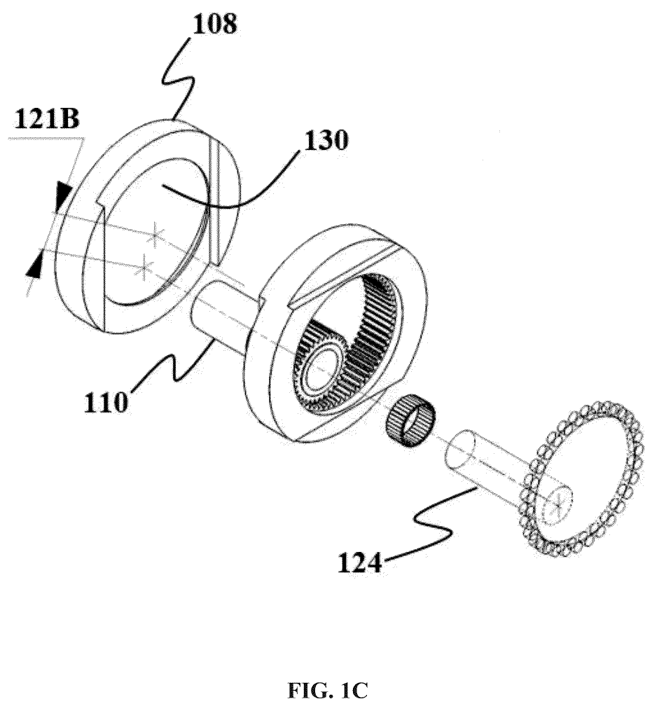

FIG. 1A shows a schematic of an exploded right view of a coaxial crank speed reducer, consistent with one or more exemplary embodiments of the present disclosure. An exemplary crank speed reducer 100 may include a first middle planetary ring gear 102, a rotating mechanism, a first output sun gear 104, a first driven ring wheel 106, a second driven ring wheel 108, and a central output shaft 110.

In an exemplary embodiment, first middle planetary ring gear 102 may include a first internal-cut gear 112 inside a cylindrical internal surface of first middle planetary ring gear 102. In an exemplary embodiment, a rotation axis of first internal-cut gear 112 may overlap and may be along with a central normal axis of first middle planetary ring gear 102.

In an exemplary embodiment, first output sun gear 104 may be meshed with first internal-cut gear 112. In an exemplary embodiment, first output sun gear 104 may be placed inside first middle planetary ring gear 102 so that it may engage with first internal-cut gear 112. In an exemplary embodiment, first output sun gear 104 may be an external-toothed gear that may have a smaller diameter compared to first internal-cut gear 112. In an exemplary embodiment, first output sun gear 104 may be encircled by first middle planetary ring gear 102 such that the external teeth of first output sun gear 104 may mesh with the internal teeth of first internal-cut gear 112. In an exemplary embodiment, a rotation axis of first output sun gear 104 may be parallel with the central normal axis of first middle planetary ring gear 102. In an exemplary embodiment, first output sun gear 104 may be rotatable with first middle planetary ring gear 102.

In an exemplary embodiment, first driven ring wheel 106 may be rotatable about a first rotation axis 114. In an exemplary embodiment, first rotation axis 114 may overlap and may be along with a central normal axis of first driven ring wheel 106 and may be parallel with the central normal axis of first middle planetary ring gear 102. In an exemplary embodiment, first driven ring wheel 106 may be coupled to first middle planetary ring gear 102 from a first side 115A of first middle planetary ring gear 102 utilizing a first prismatic joint 116. In an exemplary embodiment, first prismatic joint 116 may be disposed on a plane that may be perpendicular to first rotation axis 114. In an exemplary embodiment, first prismatic joint 116 may transfer the rotational movement of first middle planetary ring gear 102 to first driven ring wheel 106 and may force first driven ring wheel 106 to rotate about first rotation axis 114.

In an exemplary embodiment, second driven ring wheel 108 may be rotatable about a second rotation axis 118. In an exemplary embodiment, second rotation axis 118 may overlap and may be along with a central normal axis of second driven ring wheel 108 and may be parallel with the central normal axis of first middle planetary ring gear 102. In an exemplary embodiment, second driven ring wheel 108 may be used as a second flange coupled to first middle planetary ring gear 102 from a second side 115B of first middle planetary ring gear 102. In an exemplary embodiment, second side 115B may be opposite to first side 115A along a central axis 120. An exemplary second prismatic joint 122 may be utilized to couple second driven ring wheel 108 to first middle planetary ring gear 102. In an exemplary embodiment, second prismatic joint 122 may be disposed on a plane that may be perpendicular to second rotation axis 118 and may transfer the rotational movement of first middle planetary ring gear 102 to second driven ring wheel 108. In an exemplary embodiment, a sliding direction of second prismatic joint 122 may be perpendicular to a sliding direction of first prismatic joint 116.

In an exemplary embodiment, central output shaft 110 may be coaxially coupled to or integrated with first output sun gear 104. In an exemplary embodiment, central output shaft 110 may be rotatable with first output sun gear 104 about central axis 120. In an exemplary embodiment, central axis 120 may overlap and may be along with a central longitudinal axis of central output shaft 110.

In an exemplary embodiment, first rotation axis 114, second rotation axis 118, and central axis 120 may be parallel with each other and may lie on a single plane. In an exemplary embodiment, first rotation axis 114 and second rotation axis 118 may be symmetrically disposed on either side of central axis 120 with equal respective distances from central axis 120. In other words, an exemplary distance 121A of first rotation axis 114 from central axis 120 may be equal to an exemplary distance 121B of second rotation axis 118 from central axis 120. Therefore, in an exemplary embodiment, first rotation axis 114 and second rotation axis 118 may have an offset relative to each other with a distance equal to a sum of distances 121A and 121B.

An exemplary rotating mechanism may be directly connected to first middle planetary ring gear 102 and may drive a rotational movement of first middle planetary ring gear 102. An exemplary rotating mechanism may include an input shaft 124 and an eccentric cylinder 126 that may be attached to one end of input shaft 124. In an exemplary embodiment, input shaft 124 may be rotatable about central axis 120. In an exemplary embodiment, input shaft 124 may be partially hollow. For example, input shaft 124 may have a central hole 127 that may allow central output shaft 110 to coaxially pass through input shaft 124 and lean on a bearing 128 so that bearing 128 may allow central output shaft 110 to rotate relative to input shaft 124 about central axis 120. An exemplary first end of central output shaft 110—which may be coaxially inserted into central hole 127—may lean on bearing 128 inside input shaft 124 that may be a support for one end of both input shaft 124 and central output shaft 110 in an intermediate portion of central axis 120. In an exemplary embodiment, input shaft 124 may be coupled to an external motor, such as an electric motor or an internal combustion engine.

FIG. 1B shows a schematic of an exploded view of an input shaft inserted inside a hollow output shaft, consistent with one or more exemplary embodiments of the present disclosure. Referring to FIGS. 1A and 1B, in an exemplary embodiment, central output shaft 110 may be partially hollow and may allow input shaft 124 to coaxially pass through central output shaft 110. An exemplary end 123 of input shaft 124—which may be coaxially inserted into central output shaft 110—may rest on a bearing 125 (similar to bearing 128) inside central output shaft 110. In an exemplary embodiment, input shaft 124 may be coupled to an external motor, such as an electric motor or an internal combustion engine.

Referring again to FIG. 1A, in an exemplary embodiment, first driven ring wheel 106 may include a first central hole 129. In an exemplary embodiment, first central hole 129 may allow one of input shaft 124 and central output shaft 110 to pass through first driven ring wheel 106.

FIG. 1C shows a schematic of a driven ring wheel of a coaxial crank speed reducer with a central hole, consistent with one or more exemplary embodiments of the present disclosure. Referring to FIGS. 1A and 1C, in an exemplary embodiment, second driven ring wheel 108 may include a second central hole 130. In an exemplary embodiment, second central hole 130 may allow one of input shaft 124 and central output shaft 110 to pass through second driven ring wheel 108.

In an exemplary embodiment, eccentric cylinder 126 may be attached to one end of input shaft 124. In an exemplary embodiment, an eccentricity of eccentric cylinder 126 relative to central axis 120 may be equal to distance 121A of first rotation axis 114 or distance 121B of second rotation axis 118 from central axis 120.

In an exemplary embodiment, first middle planetary ring gear 102 may further include a central hole 131 and a bearing 132. In an exemplary embodiment, bearing 132 may be fitted to central hole 131 and may allow first middle planetary ring gear 102 to rotate relative to eccentric cylinder 126 about the central normal axis of first middle planetary ring gear 102 by rotatably coupling eccentric cylinder 126 to first middle planetary ring gear 102. An exemplary plane of rotation of first middle planetary ring gear 102 may be perpendicular to central axis 120.

In an exemplary embodiment, crank speed reducer 100 may further include a first wall 133 and a second wall 134. In an exemplary embodiment, first wall 133 may include a first bearing 136. In an exemplary embodiment, first bearing 136 may be coupled to first driven ring wheel 106 and may allow first driven ring wheel 106 to rotate about first rotation axis 114. In an exemplary embodiment, second wall 134 may include a second bearing 138. In an exemplary embodiment, second bearing 138 may be coupled to second driven ring wheel 108 and may allow second driven ring wheel 108 to rotate about second rotation axis 118. In an exemplary embodiment, first wall 114 and second wall 116 may be fixed in position with respect to each other.

In an exemplary embodiment, first wall 133 may further include a first central hole 140. In an exemplary embodiment, first central hole 140 may be fitted with a third bearing 142 and may allow one of input shaft 124 and central output shaft 110 to pass through first wall 133 and be rotatably coupled to first wall 133 through third bearing 142. In an exemplary embodiment, second wall 134 may further include a second hole 144. In an exemplary embodiment, second hole 144 may be fitted with a fourth bearing 146 and may allow one of input shaft 124 and central output shaft 110 to pass through second wall 134 and be rotatably coupled to second wall 134 through fourth bearing 146.

In an exemplary embodiment, first wall 133 and second wall 134 may be parallel and collinear with each other. In an exemplary embodiment, such parallelism and constant spacing of first wall 133 and second wall 134 may be achieved by clamping or securing first wall 133 and second wall 134 to a shell (not shown in FIG. 1 for simplicity). An exemplary shell may house internal components of crank speed reducer 100.

In an exemplary embodiment, an eccentricity (or offset) of first driven ring wheel 106 from central axis 120 by distance 121A from a top view of central axis 120 and an eccentricity (or offset) of second driven ring wheel 108 from central axis 120 by second distance 121B on an opposite side from the top view of central axis 120 may be equal. In an exemplary embodiment, such configuration and coupling of first driven ring wheel 106 and second driven ring wheel 108 to two sides 115A and 115B of first middle planetary ring gear 102 using mutually perpendicular prismatic joints 116 and 122 may cause first middle planetary ring gear 102 to perform a compound rotation in response to a rotation of input shaft 124. An exemplary compound rotation of first middle planetary ring gear 102 may consist of a spin about the central normal axis of first middle planetary ring gear 102 and a revolution around central axis 120 on a circular orbit with a radius equal to distance 121A or distance 121B. In an exemplary embodiment, a “central normal axis” of first middle planetary ring gear 102 may refer to an axis perpendicular to a largest surface or one of the two sides 115A and 115B of first middle planetary ring gear 102 that may pass through a center of first middle planetary ring gear 102. Exemplary spinning and revolutionary motions of first middle planetary ring gear 102 may be transmitted to first output sun gear 104. In an exemplary response to such compound movement of first middle planetary ring gear 102, first output sun gear 104 may rotate around its central axis which may be same as central axis 120. As a result, an exemplary rotational movement of first output sun gear 104 may be directly transmitted to central output shaft 110.

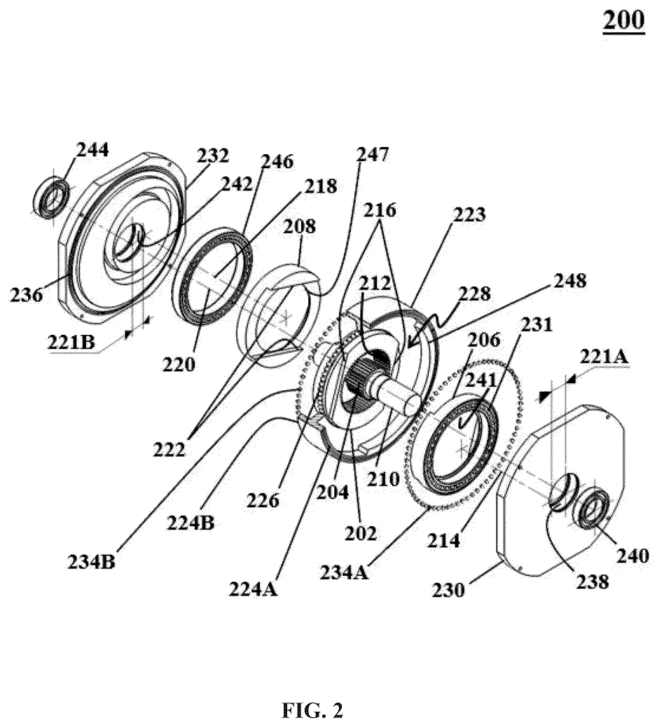

FIG. 2 shows a schematic of an exploded right view of a rotating-wall crank speed reducer, consistent with one or more exemplary embodiments of the present disclosure. An exemplary crank speed reducer 200 may include a first middle planetary ring gear 202, a rotating mechanism, a first output sun gear 204, a first driven ring wheel 206, a second driven ring wheel 208, and a central output shaft 210.

In an exemplary embodiment, first middle planetary ring gear 202 may be analogous to first middle planetary ring gear 102 and may include a first internal-cut gear 212 (similar to first internal-cut gear 112) inside a cylindrical internal surface of first middle planetary ring gear 202. In an exemplary embodiment, a rotation axis of first internal-cut gear 212 may overlap and may be along with a central normal axis of first middle planetary ring gear 202.

In an exemplary embodiment, first output sun gear 204 may be analogous to first output sun gear 104 and may be meshed with first internal-cut gear 212. In an exemplary embodiment, first output sun gear 204 may be placed inside first middle planetary ring gear 202 so that it may engage with first internal-cut gear 212. In an exemplary embodiment, first output sun gear 204 may be an external-toothed gear that may have a smaller diameter compared to first internal-cut gear 212. In an exemplary embodiment, first output sun gear 204 may be encircled by first middle planetary ring gear 202 such that the external teeth of first output sun gear 204 may mesh with the internal teeth of first internal-cut gear 212. In an exemplary embodiment, a rotation axis of first output sun gear 204 may be parallel with the central normal axis of first middle planetary ring gear 202. In an exemplary embodiment, first output sun gear 204 may be rotatable with first middle planetary ring gear 202.

In an exemplary embodiment, first driven ring wheel 206 may be analogous to first driven ring wheel 106 and may be rotatable about a first rotation axis 214 (similar to first rotation axis 114). In an exemplary embodiment, first rotation axis 214 may overlap and may be along with a central normal axis of first driven ring wheel 206 and may be parallel with the central normal axis of first middle planetary ring gear 202. In an exemplary embodiment, first driven ring wheel 206 may be coupled to first middle planetary ring gear 202 from a first side (similar to first side 115A) of first middle planetary ring gear 202 utilizing a first prismatic joint 216 (similar to first prismatic joint 116). In an exemplary embodiment, first prismatic joint 216 may be disposed on a plane that may be perpendicular to first rotation axis 214. In an exemplary embodiment, first prismatic joint 216 may transfer the rotational movement of first middle planetary ring gear 202 to first driven ring wheel 206 and may force first driven ring wheel 206 to rotate about first rotation axis 214.

In an exemplary embodiment, second driven ring wheel 208 may be analogous to second driven ring wheel 108 and may be rotatable about a second rotation axis 218 (similar to second rotation axis 118). In an exemplary embodiment, second rotation axis 218 may overlap and may be along with a central normal axis of second driven ring wheel 208 and may be parallel with the central normal axis of first middle planetary ring gear 202. In an exemplary embodiment, second driven ring wheel 208 may be used as a second flange coupled to first middle planetary ring gear 202 from a second side (similar to second side 115B) of first middle planetary ring gear 202. In an exemplary embodiment, the second side of first middle planetary ring gear 202 may be opposite to the first side of first middle planetary ring gear 202 along a central axis 220 (similar to central axis 120). An exemplary second prismatic joint 222 (similar to second prismatic joint 122) may be utilized to couple second driven ring wheel 208 to first middle planetary ring gear 202. In an exemplary embodiment, second prismatic joint 222 may be disposed on a plane that may be perpendicular to second rotation axis 218 and may transfer the rotational movement of first middle planetary ring gear 202 to second driven ring wheel 208. In an exemplary embodiment, a sliding direction of second prismatic joint 222 may be perpendicular to a sliding direction of first prismatic joint 216.

In an exemplary embodiment, central output shaft 210 may be analogous to central output shaft 110 and may be coaxially coupled to or integrated with first output sun gear 204. In an exemplary embodiment, central output shaft 210 may be rotatable with first output sun gear 204 about central axis 220. In an exemplary embodiment, central axis 220 may overlap and may be along with a central longitudinal axis of central output shaft 210.

In an exemplary embodiment, first rotation axis 214, second rotation axis 218, and central axis 220 may be parallel with each other and may lie on a single plane. In an exemplary embodiment, first rotation axis 214 and second rotation axis 218 may be symmetrically disposed on either side of central axis 220 with equal respective distances from central axis 220. In other words, an exemplary distance 221A of first rotation axis 214 from central axis 220 may be equal to an exemplary distance 221B of second rotation axis 218 from central axis 220. Therefore, in an exemplary embodiment, first rotation axis 214 and second rotation axis 218 may have an offset relative to each other with a distance equal to a sum of distances 221A and 221B.

An exemplary rotating mechanism may be directly connected to first middle planetary ring gear 202 and may drive a rotational movement of first middle planetary ring gear 202. An exemplary rotating mechanism may include a rotating wall 223, a first bearing (for example, a bearing 224A or a bearing 224B or both), and a second bearing 226. In an exemplary embodiment, rotating wall 223 may include an eccentric hole 228. In an exemplary embodiment, a central normal axis of eccentric hole 228 may be parallel with central axis 220 and an eccentricity of eccentric hole 228 relative to central axis 220 may be equal to distance 221A of first rotation axis 214 from the central axis 220. In an exemplary embodiment, eccentric hole 228 may be rotatably coupled to first middle planetary ring gear 202 by means of second bearing 226.

In an exemplary embodiment, crank speed reducer 200 may further include a first wall 230 (similar to first wall 133) and a second wall 232 (similar to second wall 134). In an exemplary embodiment, first wall 230 may include a first bearing 231 (similar to first bearing 136). In an exemplary embodiment, first bearing 231 may be coupled to first driven ring wheel 206 and may allow first driven ring wheel 206 to rotate about first rotation axis 214. In an exemplary embodiment, second wall 232 may include a second bearing 246 (similar to second bearing 138). In an exemplary embodiment, second bearing 246 may be coupled to second driven ring wheel 208 and may allow second driven ring wheel 208 to rotate about second rotation axis 218. In an exemplary embodiment, first wall 230 and second wall 232 may be fixed in position with respect to each other.

In an exemplary embodiment, bearing 224A may be fitted to rotating wall 223 and may allow rotating wall 223 to rotate about central axis 220. In an exemplary embodiment, bearings 224A and 224B may be concentric with central axis 220 and may rotatably couple rotating wall 223 to a first wall 230 and a second wall 232 by means of plurality of balls or rollers like rollers 234A and 234B between corresponding grooves like grooves of bearings 224B and 236. In an exemplary embodiment, second bearing 226 may be fitted to eccentric hole 228 and may rotatably couple first middle planetary ring gear 202 to eccentric hole 228. In an exemplary embodiment, a plane of rotation of first middle planetary ring gear 202 may be perpendicular to central axis 220. In an exemplary embodiment, rotating wall 223 may be either driven by an external motor—such as an electric motor—by means of, for example, a pulley-belt system, or may be itself a rotor of an electric motor so that rotating wall 223 may rotate about central axis 220 leaning on one of or both bearings 224A and 224B.

In an exemplary embodiment, first wall 230 may further include a first central hole 238. In an exemplary embodiment, first hole 238 may be fitted with a third bearing 240 (similar to third bearing 142) and may allow central output shaft 210 to pass through first wall 230 and be rotatably coupled to first wall 230 by means of third bearing 240. An exemplary inner hole of bearing 231 may be large enough to allow central output shaft 210 to pass through first driven ring wheel 206 without contact. In an exemplary embodiment, first driven ring wheel 206 may also include a central hole 241 that may allow central output shaft 210 to pass through first driven ring wheel 206 without contact.

In an exemplary embodiment, second wall 232 may include a second central hole 242 (similar to first central hole 144) which may be equipped with a bearing 244. In an exemplary embodiment, second central hole 242 may allow central output shaft 210 to rotatably pass through second wall 232 while central output shaft 210 may lean on bearing 244. In an exemplary embodiment, second wall 232 may further include a bearing 246 that may be coupled to second driven ring wheel 208 and may allow second driven ring wheel 208 to rotate about second rotation axis 218. An exemplary inner hole of bearing 246 may be large enough to allow central output shaft 210 to pass through second driven ring wheel 208 without contact. In an exemplary embodiment, second driven ring wheel 208 may also include a central hole 247 that may allow central output shaft 210 to pass through second driven ring wheel 208 without contact.

In an exemplary embodiment, first wall 230 and second wall 232 may be parallel and collinear with each other. In an exemplary embodiment, such parallelism and constant spacing of first wall 230 and second wall 232 may be achieved by clamping or securing first wall 230 and second wall 232 to a shell. An exemplary shell may house internal components of crank speed reducer 200.

In an exemplary embodiment, an eccentricity (or offset) of first driven ring wheel 206 from central axis 220 by distance 221A from a top view of central axis 220 and an eccentricity (or offset) of second driven ring wheel 208 from central axis 220 by second distance 221B on an opposite side from the top view of central axis 220 may be equal. In an exemplary embodiment, such configuration and coupling of first driven ring wheel 206 and second driven ring wheel 208 to the two sides of first middle planetary ring gear 202 using mutually perpendicular prismatic joints 216 and 222 may cause first middle planetary ring gear 202 to perform a compound rotation in response to a rotation of rotating wall 223. An exemplary compound rotation of first middle planetary ring gear 202 may consist of a spin about the central normal axis of first middle planetary ring gear 202 and a revolution around central axis 220 on a circular orbit with a radius equal to distance 221A or distance 221B. In an exemplary embodiment, a “central normal axis” of first middle planetary ring gear 202 may refer to an axis perpendicular to a largest surface or one of the two sides of first middle planetary ring gear 202 that may pass through a center of first middle planetary ring gear 202. Exemplary spinning and revolutionary motions of first middle planetary ring gear 202 may be transmitted to first output sun gear 204. In an exemplary response to such compound movement of first middle planetary ring gear 202, first output sun gear 204 may rotate around its central axis which may be same as central axis 220. As a result, an exemplary rotational movement of first output sun gear 204 may be directly transmitted to central output shaft 210.

In an exemplary embodiment, an eccentricity (or offset) of first middle planetary ring gear 202 from central axis 220 may cause unbalance rotation of rotating wall 223. To make it balanced, an exemplary counterweight 248 may be attached to or may be integrally formed with rotating wall 223 so that its eccentricity may be opposite to eccentricities of eccentric hole 228 and first middle planetary ring gear 202. An exemplary mass of counterweight 248 may be so calculated to counterbalance a centrifugal force of first middle planetary ring gear 202.

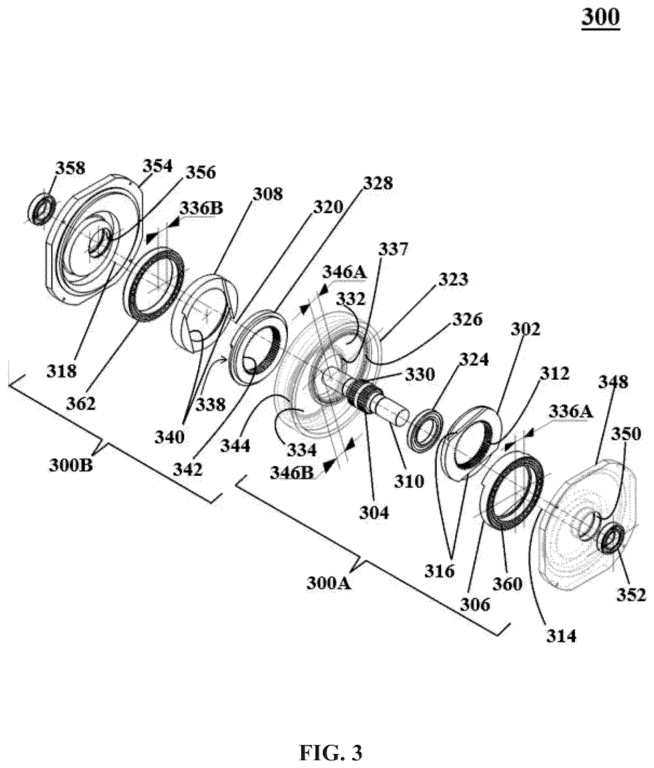

FIG. 3 shows a schematic of an exploded right view of a twin-planet crank speed reducer with a rotating wall, consistent with one or more exemplary embodiments of the present disclosure. An exemplary crank speed reducer 300 may include a first middle planetary ring gear 302, a rotating mechanism, a first output sun gear 304, a first driven ring wheel 306, a second driven ring wheel 308, and a central output shaft 310.

Referring to FIGS. 1A and 3, in an exemplary embodiment, first middle planetary ring gear 302 may be analogous to first middle planetary ring gear 102 and may include a first internal-cut gear 312 (similar to first internal-cut gear 112) inside a cylindrical internal surface of first middle planetary ring gear 302. In an exemplary embodiment, a rotation axis of first internal-cut gear 312 may overlap and may be along with a central normal axis of first middle planetary ring gear 302.

An exemplary rotating mechanism may be directly connected to first middle planetary ring gear 302 and may drive a rotational movement of first middle planetary ring gear 302. In an exemplary embodiment, first output sun gear 304 may be analogous to first output sun gear 104 and may be meshed with first internal-cut gear 312. In an exemplary embodiment, first output sun gear 304 may be placed inside first middle planetary ring gear 302 so that first output sun gear 304 may engage with first internal-cut gear 312. In an exemplary embodiment, first output sun gear 304 may be an external-toothed gear that may have a smaller diameter compared to first internal-cut gear 312. In an exemplary embodiment, first output sun gear 304 may be encircled by first middle planetary ring gear 302 such that the external teeth of first output sun gear 304 may mesh with the internal teeth of first internal-cut gear 312. In an exemplary embodiment, a rotation axis of first output sun gear 304 may be parallel with the central normal axis of first middle planetary ring gear 302. In an exemplary embodiment, first output sun gear 304 may be rotatable with first middle planetary ring gear 302.

In an exemplary embodiment, first driven ring wheel 306 may be analogous to first driven ring wheel 106 and may be rotatable about a first rotation axis 314 (similar to first rotation axis 114). In an exemplary embodiment, first rotation axis 314 may overlap and may be along with a central normal axis of first driven ring wheel 306 and may be parallel with the central normal axis of first middle planetary ring gear 302. In an exemplary embodiment, first driven ring wheel 306 may be coupled to first middle planetary ring gear 302 from a first side (similar to first side 115A) of first middle planetary ring gear 302 utilizing a first prismatic joint 316 (similar to first prismatic joint 116). In an exemplary embodiment, first prismatic joint 316 may be disposed on a plane that may be perpendicular to first rotation axis 314. In an exemplary embodiment, first prismatic joint 316 may transfer the rotational movement of first middle planetary ring gear 302 to first driven ring wheel 306.

In an exemplary embodiment, second driven ring wheel 308 may be analogous to second driven ring wheel 108 and may be rotatable about a second rotation axis 318 (similar to second rotation axis 118). In an exemplary embodiment, second rotation axis 318 may overlap and may be along with a central normal axis of second driven ring wheel 308 and may be parallel with the central normal axis of first middle planetary ring gear 302.

In an exemplary embodiment, central output shaft 310 may be analogous to central output shaft 110 and may be coaxially coupled to or integrated with first output sun gear 304. In an exemplary embodiment, central output shaft 310 may be rotatable with first output sun gear 304 about a central axis 320. In an exemplary embodiment, central axis 320 may overlap and may be along with a central longitudinal axis of central output shaft 310.

An exemplary rotating mechanism may include a rotating wall 323, a first bearing 324, a second bearing 326, a second middle planetary ring gear 328, and a second output sun gear 330. In an exemplary embodiment, rotating wall 323 may include a first eccentric hole 332 and a second eccentric hole 334. In an exemplary embodiment, first eccentric hole 332 may be located at a proximal side of rotating wall 323. An exemplary proximal side may face first middle planetary ring gear 302. In an exemplary embodiment, eccentric holes 332 and 334 may be concentric or nonconcentric holes relative to each other and may have correspondingly either same or different central axes which may be parallel with central axis 320. An exemplary central normal axis of first eccentric hole 332 may be parallel with central axis 320 and an eccentricity of first eccentric hole 332 relative to central axis 320 may be equal to a distance 336A of first rotation axis 314 from the central axis 320. In an exemplary embodiment, a central normal axis of second eccentric hole 334 may be parallel with central axis 320 and an eccentricity of second eccentric hole 334 relative to central axis 320 may be equal to a distance 336B of second rotation axis 318 from central axis 320. In an exemplary embodiment, first eccentric hole 332 and second eccentric hole 334 may be disposed on opposite sides of rotating wall 323.

In an exemplary embodiment, first bearing 324 may be fitted to a central hole 337 of rotating wall 323 and may allow rotating wall 323 to rotate about central axis 320. In an exemplary embodiment, first bearing 324 may rotatably couple rotating wall 323 to an intermediate portion of output shaft 310. In an exemplary embodiment, rotating wall 323 may be either driven by an external motor (for example, an electric motor) by means of, for example, a pulley-belt system, or may be itself a rotor of an electric motor. In an exemplary embodiment, second bearing 326 may be fitted to first eccentric hole 332. In an exemplary embodiment, second bearing 326 may rotatably couple first middle planetary ring gear 302 to first eccentric hole 332 and may allow first middle planetary ring gear 302 to rotate relative to rotating wall 323 about the central normal axis of first middle planetary ring gear 302. An exemplary plane of rotation of first middle planetary ring gear 302 may be perpendicular to central axis 320.

In an exemplary embodiment, second middle planetary ring gear 328 may be coupled to second driven ring wheel 308 from a respective side 338 of second middle planetary ring gear 328 utilizing a second prismatic joint 340. In an exemplary embodiment, second prismatic joint 340 may transfer a rotational movement of second middle planetary ring gear 328 to second driven ring wheel 308. In an exemplary embodiment, side 338 of second middle planetary ring gear 328 may be positioned opposite to the first side of the first middle planetary ring gear 302 along central axis 320. In an exemplary embodiment, second middle planetary ring gear 328 may include a second internal-cut gear 342 inside a cylindrical internal surface of second middle planetary ring gear 328. An exemplary rotation axis of second internal-cut gear 342 may overlap and may be along with a central normal axis of second middle planetary ring gear 328.

An exemplary rotating mechanism may further include a third bearing 344. In an exemplary embodiment, second eccentric hole 334 may be fitted to third bearing 344. In an exemplary embodiment, third bearing 344 may rotatably couple second middle planetary ring gear 328 to second eccentric hole 334 and may allow second middle planetary ring gear 328 to rotate relative to rotating wall 323 about the central normal axis of second middle planetary ring gear 328. An exemplary plane of rotation of second middle planetary ring gear 328 may be perpendicular to central axis 320. As a result, in an exemplary embodiment, rotating wall 323 may act as a separator between middle planetary ring gears 302 and 328. In an exemplary embodiment, each of middle planetary ring gears 302 and 328 may rotate freely about its respective central normal axis.

In an exemplary embodiment, second output sun gear 330 may be meshed with second middle planetary ring gear 328 and may be rotatable with second middle planetary ring gear 328 about the central axis 320. In an exemplary embodiment, second output sun gear 330 may be placed inside second middle planetary ring gear 328 so that second output sun gear 330 may engage with second internal-cut gear 342. In an exemplary embodiment, second output sun gear 330 may be an external-toothed gear that may have a smaller diameter compared to second internal-cut gear 342. In an exemplary embodiment, second output sun gear 330 may be encircled by second middle planetary ring gear 328 such that the external teeth of second output sun gear 330 may mesh with the internal teeth of second internal-cut gear 342.

An exemplary central normal axis of second output sun gear 330 may overlap and may be along with central axis 320. In an exemplary embodiment, a gear ratio between second middle planetary ring gear 328 and second output sun gear 330 may be equal to a gear ratio between first middle planetary ring gear 302 and first output sun gear 304. In an exemplary embodiment, second output sun gear 330 may be attached to central output shaft 310. In an exemplary embodiment, central output shaft 310 may be coaxially coupled to or integrated with second output sun gear 330. In an exemplary embodiment, central output shaft 310 may be rotatable with second output sun gear 330.

In an exemplary embodiment, second output sun gear 330 may be concentric with first output sun gear 304 and may have a fixed position relative to first output sun gear 304. In response to an exemplary meshing of conjoined output sun gears 304 and 330 with middle planetary ring gears 302 and 328 respectively, two middle planetary ring gears 302 and 328 may be constrained to each other so that they may only rotate with a same angular velocity. Hence, exemplary fabrication and initial engagement of the internal-cut gears 312 and 342 with output sun gears 304 and 330 may be so adjusted that prismatic joints 316 and 340 may be permanently kept perpendicular to each other.

In an exemplary embodiment, crank speed reducer 300 may consist of two sections 300A and 300B which may be separated by rotating wall 323. In an exemplary embodiment, sections 300A and 300B may have a geometrical correspondence as defined by the following:

$$\frac{{E}_{A 1}}{{E}_{A 2}} = \frac{{E}_{P 1}}{{E}_{P 2}} = \frac{{D}_{S 1}}{{D}_{S 2}} = \frac{{D}_{I 1}}{{D}_{I 2}} \qquad Equation ( 1 )$$

where E_{A1} is a value of distance 336A, E_{A2} is a value of distance 336B, E_{P1} is a value of an eccentricity 346A of a central axis of first hole 332 relative to central axis 320, E_{P2} is a value of an eccentricity 346B of a central axis of second hole 334 relative to central axis 320, D_{S1} is a pitch diameter of first output sun gear 304, D_{S2} is a pitch diameter of second output sun gear 330, D_{I1}, is a pitch diameter of first internal-cut gear 312, and D_{I2} is a pitch diameter of second internal-cut gear 342.

In an exemplary embodiment, crank speed reducer 300 may further include a first wall 348 which may include a first central hole 350. In an exemplary embodiment, first central hole 350 may be equipped with a bearing 352. In an exemplary embodiment, first central hole 350 may allow central output shaft 310 to rotatably pass through first wall 348. In an exemplary embodiment, central output shaft 310 may be supported with bearing 352. An exemplary first end of central output shaft 310 may be coaxially inserted into the first central hole 350 and may lean on bearing 352 inside the first wall 348.

In an exemplary embodiment, crank speed reducer 300 may further include a second wall 354 which may include a second central hole 356. In an exemplary embodiment, second central hole 356 may be equipped with a bearing 358. In an exemplary embodiment, second central hole 356 may allow central output shaft 310 to rotatably pass through second wall 354 while central output shaft 310 may lean on bearing 358. An exemplary second end of central output shaft 310 may be coaxially inserted into central hole 356 and may lean on bearing 358 inside the second wall 354.

In an exemplary embodiment, first wall 348 may further include a bearing 360 that may be coupled to first driven ring wheel 306 and may allow first driven ring wheel 306 to rotate about first rotation axis 314. In an exemplary embodiment, second wall 354 may include a bearing 362 that may be couple to second driven ring wheel 308 and allow second driven ring wheel 308 to rotate about second rotation axis 318. In an exemplary embodiment, first wall 348 and second wall 354 may be parallel and collinear with each other. In an exemplary embodiment, such parallelism and constant spacing of first wall 348 and second wall 354 relative to each other may be achieved by clamping or securing first wall 348 and second wall 354 to a shell (not shown in FIG. 3 for simplicity). An exemplary shell may house internal components of crank speed reducer 300.

In an exemplary embodiment, bearing 360 may be concentric with first driven ring wheel 306. In an exemplary embodiment, bearing 360 may rotatably couple first driven ring wheel 306 to first wall 348 and may allow first driven ring wheel 306 to rotate about first rotation axis 314. An exemplary inner hole of third bearing 360 may be large enough to allow central output shaft 310 to pass through first driven ring wheel 306 without contact. In an exemplary embodiment, first driven ring wheel 306 may also include a central hole that may allow central output shaft 310 to pass through first driven ring wheel 306 without contact.

In an exemplary embodiment, bearing 362 may be concentric with second driven ring wheel 308 and may rotatably couple second driven ring wheel 308 to second wall 354. In an exemplary embodiment, bearing 362 may allow second driven ring wheel 308 rotate about second rotation axis 318. An exemplary inner hole of bearing 362 may be large enough to allow central output shaft 310 pass through second driven ring wheel 308 without contact. In an exemplary embodiment, second driven ring wheel 308 may also include a central hole that may allow central output shaft 310 to pass through second driven ring wheel 308 without contact.

In an exemplary embodiment, first rotation axis 314, second rotation axis 318, and central axis 320 may not necessarily lie on a common plane. However, for balancing crank speed reducer 300, in an exemplary embodiment, eccentricities 346A and 346B may be disposed on opposing sides of central axis 320. In an exemplary embodiment, distance 346A of the central axis of first middle planetary ring gear 302 from central axis 320 may not be necessarily equal to distance 346B of the central axis of second planetary ring gear 328 from central axis 320. while Equation (1) is held. However, in an exemplary embodiment, the eccentricity of first eccentric hole 332 relative to central axis 320 may be equal to eccentricity 336A of first rotational axis 314 relative to central axis 320. and the eccentricity of second eccentric hole 334 relative to central axis 320 may be equal to eccentricity 336B of second rotational axis 318 relative to central axis 320.

In an exemplary embodiment, if the eccentricities of two bearings 326 and 344 are opposite to each other relative to central axis 320, then eccentricities 336A and 336B of the two driven ring wheels 306 and 308 may be set in a same side relative to central axis 320 to keep prismatic joints 316 and 340 perpendicular to each other.

An exemplary eccentricity (or offset) of first driven ring wheel 306 from central axis 320 and an exemplary eccentricity (or offset) of first middle planetary ring gear 302 from central axis 320 may be equal. Also, an eccentricity (or offset) of second driven ring wheel 308 from central axis 320 and an eccentricity (or offset) of second middle planetary ring gear 328 from central axis 320 may be equal. In an exemplary embodiment, such configuration and coupling of first driven ring wheel 306 to the first side of the first middle planetary ring gear 302 and second driven ring wheel 308 to the second side of second middle planetary ring gear 328 using mutually perpendicular prismatic joints 316 and 340 may cause middle planetary ring gears 302 and 328 to perform a synchronous compound rotation in response to a rotation of rotating wall 323. An exemplary synchronous compound rotation of each of middle planetary ring gears 302 and 328 may consist of a spin about corresponding normal central axes of two middle planetary ring gears 302 and 328 and a revolution around central axis 320 on a circular orbit. In an exemplary embodiment, “normal central axes” of two middle planetary ring gears 302 and 328 may respectively refer to an axis perpendicular to a largest surface or one of the two sides of each of middle planetary ring gears 302 and 328 that may pass through centers of middle planetary ring gears 302 and 328. Exemplary spinning and revolutionary motions of middle planetary ring gears 302 and 328 may be transmitted to output sun gears 304 and 330, respectively. In an exemplary response to such compound movement of middle planetary ring gears 302 and 328, output sun gears 304 and 330 may synchronously rotate about central axis 320. An exemplary rotational movement of output sun gears 304 and 330 may be directly transmitted to central output shaft 310.

In an exemplary embodiment, gear pairs 304-312 and 330-342 may be either of a spur type or of a helical type. For an exemplary helical type, helix angles of gear pair 304-312 may be opposite of those of gear pair 330-342 so that axial forces of the two gear pairs may counterbalance each other.

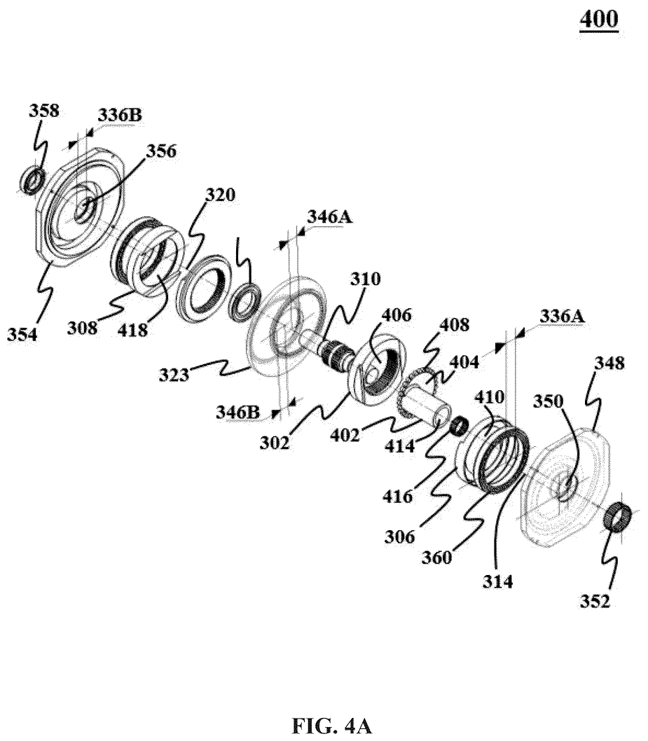

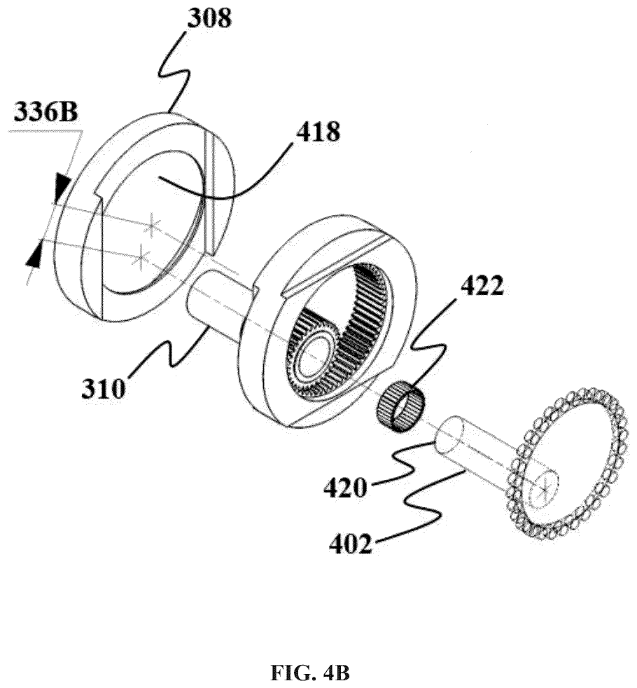

FIG. 4A shows a schematic of an exploded right view of a twin-planet crank speed reducer with a rotating wall and an input shaft, consistent with one or more exemplary embodiments of the present disclosure. An exemplary crank speed reducer 400 may include crank speed reducer 300 and some additional elements, as described below.

Referring to FIGS. 3 and 4A, an exemplary rotating mechanism may further include an input shaft 402 and an eccentric cylinder 404. In an exemplary embodiment, input shaft 402 may be rotatable about central axis 320. In an exemplary embodiment, eccentric cylinder 404 may be attached to one end of input shaft 402. An exemplary eccentricity of eccentric cylinder 404 relative to central axis 320 may be equal to distance 336A of first rotation axis 314 from central axis 320.

In an exemplary embodiment, first middle planetary ring gear 302 may further include a central hole 406. In an exemplary embodiment, central hole 406 may be fitted with a fourth bearing 408 that may allow first middle planetary ring gear 302 to rotate relative to eccentric cylinder 404 about a central normal axis of the first middle planetary ring gear 302 by rotatably coupling eccentric cylinder 404 to first middle planetary ring gear 302.

In an exemplary embodiment, an inner hole of bearing 360 may be large enough to allow input shaft 402 to pass through first driven ring wheel 306 without contact. In an exemplary embodiment, first driven ring wheel 306 may include a first central hole 410 that may allow at least one of input shaft 402 and central output shaft 310 to pass through first driven ring wheel 306 without contact. In an exemplary embodiment, first hole 350 may allow input shaft 402 to rotatably pass through first wall 348. Therefore, in an exemplary embodiment, input shaft 402 may be supported by bearing 352.

In an exemplary embodiment, input shaft 402 may be coupled to an external motor, for example, an electric motor or an internal combustion engine. In an exemplary embodiment, input shaft 402 may be a totally or partially hollow shaft with a central hole 414 that may allow central output shaft 310 to pass coaxially through input shaft 402 and lean on a bearing 416. In an exemplary embodiment, bearing 416 may allow central output shaft 310 to rotate relative to input shaft 402 about central axis 320. An exemplary proximal end of central output shaft 310—that may be coaxially inserted into central hole 414 of input shaft 402—may lean on bearing 416 inside input shaft 402. In an exemplary embodiment, bearing 416 may be a support for proximal ends (i.e., ends that are closer to first wall 348) of both input shaft 402 and central output shaft 310 in an intermediate portion of central axis 320. An exemplary distal end (i.e., an end that is closer to second wall 354) of central output shaft 310 may be coaxially inserted into second central hole 356 of second wall 354 and may lean on bearing 358 inside second wall 354.

FIG. 4B shows a schematic of a driven ring wheel of a twin-planet crank speed reducer with a central hole, consistent with one or more exemplary embodiments of the present disclosure. In an exemplary embodiment, second driven ring wheel 308 may include a second central hole 418 that may allow at least one of input shaft 402 and central output shaft 310 to pass through second driven ring wheel 308. In an exemplary embodiment, central output shaft 310 may be a totally or partially hollow shaft to allow input shaft 402 to coaxially pass through central output shaft 310. An exemplary end 420 of input shaft 402—that may be coaxially inserted into central output shaft 310—may rest on an exemplary bearing 422 inside central output shaft 310.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications, and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various implementations. This is for purposes of streamlining the disclosure, and is not to be interpreted as reflecting an intention that the claimed implementations require more features than are expressly recited in each claim. Rather, as the following claims reflect, inventive subject matter lies in less than all features of a single disclosed implementation. Thus, the following claims are hereby incorporated into the Detailed Description, with each claim standing on its own as a separately claimed subject matter.

While various implementations have been described, the description is intended to be exemplary, rather than limiting and it will be apparent to those of ordinary skill in the art that many more implementations and implementations are possible that are within the scope of the implementations. Although many possible combinations of features are shown in the accompanying figures and discussed in this detailed description, many other combinations of the disclosed features are possible. Any feature of any implementation may be used in combination with or substituted for any other feature or element in any other implementation unless specifically restricted. Therefore, it will be understood that any of the features shown and/or discussed in the present disclosure may be implemented together in any suitable combination. Accordingly, the implementations are not to be restricted except in light of the attached claims and their equivalents. Also, various modifications and changes may be made within the scope of the attached claims.

What is claimed is:

1. A crank speed reducer, comprising:
a first middle planetary ring gear comprising a first internal-cut gear inside a cylindrical internal surface of the first middle planetary ring gear, a rotation axis of the first internal-cut gear overlapping and along with a central normal axis of the first middle planetary ring gear;
a rotating mechanism directly connected to the first middle planetary ring gear and configured to drive a rotational movement of the first middle planetary ring gear;
a first output sun gear meshed with the first internal-cut gear, a rotation axis of the first output sun gear parallel with the central normal axis of the first middle planetary ring gear, the first output sun gear rotatable with the first middle planetary ring gear;
a first driven ring wheel rotatable about a first rotation axis, the first rotation axis overlapping and along with a central normal axis of the first driven ring wheel and parallel with the central normal axis of the first middle planetary ring gear, the first driven ring wheel coupled to the first middle planetary ring gear from a first side of the first middle planetary ring gear utilizing a first prismatic joint disposed on a plane perpendicular to the first rotation axis and configured to transfer the rotational movement of the first middle planetary ring gear to the first driven ring wheel;
a second driven ring wheel rotatable about a second rotation axis, the second rotation axis overlapping and along with a central normal axis of the second driven ring wheel and parallel with the central normal axis of the first middle planetary ring gear; and
a central output shaft coupled to the first output sun gear, the central output shaft rotatable with the first output sun gear about a central axis, the central axis overlapping and along with a central longitudinal axis of the central output shaft.

2. The crank speed reducer of claim 1, wherein:
the first rotation axis, the second rotation axis, and the central axis are parallel with each other and lie on a single plane; and
the first rotation axis and the second rotation axis are symmetrically disposed on either side of the central axis with equal respective distances from the central axis.

3. The crank speed reducer of claim 1, wherein the second driven ring wheel is coupled to the first middle planetary ring gear from a second side of the first middle planetary ring gear utilizing a second prismatic joint disposed on a plane perpendicular to the second rotation axis, the second prismatic joint configured to transfer the rotational movement of the first middle planetary ring gear to the second driven ring wheel, a sliding direction of the second prismatic joint perpendicular to a sliding direction of the first prismatic joint.

4. The crank speed reducer of claim 3, the rotating mechanism comprises:
an input shaft rotatable about the central axis; and
an eccentric cylinder attached to one end of the input shaft, an eccentricity of the eccentric cylinder relative to the central axis equal to the distance of the first rotation axis from the central axis.

5. The crank speed reducer of claim 4, wherein the first middle planetary ring gear further comprises:
a central hole; and
a bearing fitted to the central hole and configured to allow the first middle planetary ring gear to rotate relative to the eccentric cylinder about the central normal axis of the first middle planetary ring gear by rotatably coupling the eccentric cylinder to the first middle planetary ring gear.

6. The crank speed reducer of claim 4, further comprising:
a first wall comprising a first bearing coupled to the first driven ring wheel and configured to allow the first driven ring wheel to rotate about the first rotation axis; and
a second wall comprising a second bearing coupled to the second driven ring wheel and configured to allow the second driven ring wheel to rotate about the second rotation axis,
wherein the first wall and the second wall are fixed in position with respect to each other.

7. The crank speed reducer of claim 6, wherein the input shaft is partially hollow and configured to allow the central output shaft to coaxially pass through the input shaft.

8. The crank speed reducer of claim 6, wherein the central output shaft is partially hollow and configured to allow the input shaft to coaxially pass through the central output shaft.

9. The crank speed reducer of claim 6, wherein:
the first wall further comprises a first hole fitted with a third bearing and configured to allow one of the input shaft and the central output shaft to pass through the first wall and be rotatably coupled to the first wall through the third bearing; and
the second wall further comprises a second hole fitted with a fourth bearing and configured to allow one of the input shaft and the central output shaft to pass through the second wall and be rotatably coupled to the second wall through the fourth bearing.

10. The crank speed reducer of claim 4, wherein:
the first driven ring wheel comprises a first central hole configured to allow one of the input shaft and the central output shaft to pass through the first driven ring wheel; and
the second driven ring wheel comprises a second central hole configured to allow one of the input shaft and the central output shaft to pass through the second driven ring wheel.

11. The crank speed reducer of claim 3, wherein the rotating mechanism comprises:
a rotating wall comprising an eccentric hole;
a first bearing fitted to the rotating wall and configured to allow the rotating wall to rotate about the central axis; and
a second bearing fitted to the eccentric hole and configured to rotatably couple the first middle planetary ring gear to the eccentric hole, wherein:
a central normal axis of the eccentric hole is parallel with the central axis; and
an eccentricity of the eccentric hole relative to the central axis is equal to a distance of the first rotation axis from the central axis.

12. The crank speed reducer of claim 1, wherein the rotating mechanism comprises:
a rotating wall comprising:
a first eccentric hole located at a proximal side of the rotating wall, the proximal side facing the first middle planetary ring gear, a central normal axis of the first eccentric hole parallel with the central axis and an eccentricity of the first eccentric hole relative to the central axis equal to a distance of the first rotation axis from the central axis; and
a second eccentric hole, a central normal axis of the second eccentric hole parallel with the central axis and an eccentricity of the second eccentric hole relative to the central axis equal to a distance of the second rotation axis from the central axis, wherein the first eccentric hole and the second eccentric hole are disposed on opposite sides of the rotating wall;
a first bearing fitted to the rotating wall and configured to allow the rotating wall to rotate about the central axis;
a second bearing fitted to the first eccentric hole, the second bearing configured to rotatably couple the first middle planetary ring gear to the first eccentric hole and allow the first middle planetary ring gear to rotate about the central normal axis of the first middle planetary ring gear;
a third bearing;
a second middle planetary ring gear coupled to the second driven ring wheel from a respective side of the second middle planetary ring gear utilizing a second prismatic joint configured to transfer a rotational movement of the second middle planetary ring gear to the second driven ring wheel, the respective side of the second middle planetary ring gear positioned opposite to the first side of the first middle planetary ring gear along the central axis, the second middle planetary ring gear comprising a second internal-cut gear inside a cylindrical internal surface of the second middle planetary ring gear, a rotation axis of the second internal-cut gear overlapping and along with a normal central axis of the second middle planetary ring gear, the second eccentric hole fitted to the third bearing, the third bearing configured to rotatably couple the second middle planetary ring gear to the second eccentric hole and allow the second middle planetary ring gear to rotate about the central normal axis of the second middle planetary ring gear; and
a second output sun gear meshed with the second middle planetary ring gear and rotatable with the second middle planetary ring gear about the central axis, a central normal axis of the second output sun gear overlapping and along with the central axis and a gear ratio between the second middle planetary ring gear and the second output sun gear equal to a gear ratio between the first middle planetary ring gear and the first output sun gear, the second output sun gear attached to the central output shaft and comprising a fixed position relative to the first output sun gear.

13. The crank speed reducer of claim 12, wherein the rotating mechanism further comprises:
an input shaft rotatable about the central axis; and
an eccentric cylinder attached to one end of the input shaft, an eccentricity of the eccentric cylinder relative to the central axis equal to the distance of the first rotation axis from the central axis.

14. The crank speed reducer of claim 13, wherein the first middle planetary ring gear further comprises a central hole fitted with a fourth bearing configured to allow the first middle planetary ring gear to rotate relative to the eccentric cylinder about the central normal axis of the first middle planetary ring gear by rotatably coupling the eccentric cylinder to the first middle planetary ring gear.

15. The crank speed reducer of claim 13, wherein:
the first driven ring wheel comprises a first central hole configured to allow one of the input shaft and the central output shaft to pass through the first driven ring wheel; and
the second driven ring wheel comprises a second central hole configured to allow one of the input shaft and the central output shaft to pass through the second driven ring wheel.
